(19) United States
(12) Patent Application Publication
(10) Pub. No.: US 2015/0189478 A1
(43) Pub. Date: Jul. 2, 2015

(54) APPARATUS AND METHOD FOR LOADING RADIOMAP DATABASE, AND TERMINAL DEVICE

(71) Applicant: ELECTRONICS AND TELECOMMUNICATIONS RESEARCH INSTITUTE, Daejeon (KR)

(72) Inventors: Myung-In JI, Daejeon (KR); Joo-Young KIM, Daejeon (KR); Young-Su CHO, Daejeon (KR); Yang-Koo LEE, Daejeon (KR); Sang-Joon PARK, Daejeon (KR); Jong-Hyun PARK, Daejeon (KR)

(21) Appl. No.: 14/587,965

(22) Filed: Dec. 31, 2014

(30) Foreign Application Priority Data
Jan. 2, 2014 (KR) 10-2014-0000315

(51) Int. Cl. H04W 4/02

(52) U.S. Cl. CPC H04W 4/028; H04W 4/027

(57) ABSTRACT

An apparatus and method for loading a radiomap database (DB) and a terminal device are disclosed. The apparatus for loading a radiomap DB includes a moving information calculation unit, and a loading performance unit. The moving information calculation unit calculates the moving information of a terminal based on the difference between a previous location and estimated final location of the terminal as the terminal moves. The loading performance unit loads a radiomap DB, including information about a neighboring node of each reference point, and a radiomap DB, including information about a neighboring node of a reference point, located in a direction in which the terminal moves, based on the moving information calculated by the moving information calculation unit.

### CROSS-REFERENCE TO RELATED APPLICATION

This application claims the benefit of Korean Patent Application No. 10-2014-0000315, filed Jan. 2, 2014, which is hereby incorporated by reference herein in its entirety.

### BACKGROUND OF THE INVENTION

1. Technical Field

The present disclosure relates generally to an apparatus and method for loading a radiomap database (DB) and a terminal device, which are used for location estimation, and, more particularly, to an apparatus, a method and a terminal device that, upon estimating the location of a terminal or a user carrying the terminal by using a radiomap DB, are capable of adaptively and efficiently loading a radiomap DB in response to the movement of the terminal using information about the arrangement of the reference points (RPs) of a radiomap.

2. Description of the Related Art

Depending upon the type of infrastructure and the range of service, there are various types of location estimation technology using a wireless communication infrastructure. For example, the Global Navigation Satellite System (GNSS) is a system that is used to determine the location of a user using signals from satellites on the earth's orbit. Similarly, the Global Positioning System (GPS) of the U.S., the Global Navigation Satellite System (GLONASS) of Russia and the Galilee of Europe are being operated or will be operated.

The GNSS provides a location accuracy of 10 m or less and availability in a flat land or a suburban area in which a direct line of sight can be established between a satellite unit and a reception unit. However, in a heavily populated downtown area, which is a non-line of sight area, a location error amounts to about 50 m due to multi path error. In particular, in an indoor area, reception sensitivity is deteriorated, and thus it is difficult to acquire signals. Therefore, it is difficult to determine a location.

Of other wireless communication infrastructures, cellular-based location estimation technology is used to determine the location of a user using the location information of a mobile communication base station and measured signals. More specifically, cellular-based location estimation technology is divided into Cell-ID, Enhanced-Observed Time Difference (E-ODD), and Advanced-Forward Link Trilateration (AFLT) according to the number of base stations whose signals can be received by a terminal device. The cellular-based location estimation technology has the advantage of being capable of determining a location not only in an outdoor area but also in an indoor area because of the characteristics of a mobile communication infrastructure in which the mobile communication infrastructure covers most areas, including a downtown area and a suburban area, as a service range. However, the cellular-based location estimation technology is not suitable for application to an indoor/outdoor navigation service requiring a location accuracy of a few meters because its location estimation accuracy varies depending on the density of arrangement of base stations and also it has a relatively-low average location accuracy in the range of about 100 to 800 m.

Assited-GNSS is a technology that acquires auxiliary information from a location estimation server in order to improve the minimum reception signal sensitivity of a GNSS receiver included inside a user terminal device and to reduce the Time to First Fix. While Assited-GNSS enables rapid location determination using GNSS in an urban heavily populated area, which corresponds to a weak signal environment, it cannot achieve a significant effect in an indoor area because the strength of a signal is very weak.

Since the problem of being discontinuous and disconnected occurs upon performing location estimation both in indoor and outdoor areas, methods that can be used in both indoor and outdoor areas have been developed. Of these methods, Wi-Fi-based location estimation technology is a representative technology. Wi-Fi-based location estimation technology may be divided into a location DB-based technology and a radiomap DB-based technology.

A location DB includes information about the ID, location, transmission signal strength and signal attenuation coefficient of a Wi-Fi AP (base station) present in a service area. An agent who calculates a location receives a location DB, and estimates a location using a method, such as Cell-ID, triangulation, or Weighted Centroid Localization (WCL).

A radiomap DB includes information, such as base station information and signal strengths received at a plurality of reference points preset in a service area, and various types of statistical information. An agent who calculates a location estimates a reference point having the most similar information to be a current location by comparing currently found positioning resources with signal strengths recorded in the radiomap DB.

Generally, the size of a location DB is proportional to the number of base stations installed in a service area, and, thus, is relatively small. In contrast, the size of a radiomap DB is proportional to the product of the number of constructed reference points and the number of base stations, and, thus, is massive compared to that of a location DB. Furthermore, upon performing location estimation using a radiomap DB, the radiomap DB-based technology requires a longer time than the location DB-based technique because all radiomaps related to found information should be compared and also correlation analysis should be performed.

Meanwhile, upon performing location DB-based location estimation, the location accuracy has a large deviation because it is directly influenced by the arrangement and number of base stations. In contrast, generally, when radiomap DBs have been densely constructed, relatively accurate and stable performance having a small deviation is achieved.

As a related technology, Korean Patent Application Publication No. 2009-0043733 discloses an indoor location determination method and apparatus that calculate the location of a terminal based on the strengths of received signals using an indoor infrastructure that is configured using a wireless network.

As another related technology, Korean Patent Application Publication No. 2012-0010114 discloses a location-based service system and method for performing indoor navigation, which are capable of accurately estimating the location of a mobile terminal in an indoor area, such as the inside area of a building, the underground area of a building, or a tunnel, providing path information, and increasing the accuracy of the estimation of the location of a mobile terminal because this technology can mitigate or remove Wi-Fi signal ghosting that occurs in the process of receiving a Wi-Fi signal.

### SUMMARY OF THE INVENTION

Accordingly, at least one embodiment of the present invention is intended to provide an apparatus and method for loading a radiomap DB and a terminal device, which enable rapid location estimation while preserving the accuracy and stability of a radiomap DB-based location estimation technology.

In particular, at least one embodiment of the present invention is intended to provide an apparatus and method for loading a radiomap DB and a terminal device, which are capable of overcoming the limitation of the conventional technology in which, in a service requiring continuously location estimation, an overall range should be searched again in order to search for a radiomap to be loaded when the location of a terminal has been changed.

For this purpose, the present invention is configured to previously determine and manage information about the arrangement of the reference points (RPs) of a radiomap DB. This information enables a reference point, which should be additionally loaded in accordance with a direction and distance in and by which a terminal has moved, to be rapidly determined and then loaded. Furthermore, in the same manner, the information enables a reference point, which should not be loaded any more in accordance with the direction and distance in and by which the terminal has moved, to be rapidly determined and then unloaded.

In accordance with an aspect of the present invention, there is provided an apparatus for loading a radiomap DB, including a moving information calculation unit configured to calculate the moving information of a terminal based on the difference between a previous location and estimated final location of the terminal as the terminal moves; and a loading performance unit configured to load a radiomap DB including information about a neighboring node of a reference point, located in a direction in which the terminal moves, based on a radiomap DB including information about a neighboring node of each reference point and the moving information calculated by the moving information calculation unit.

The loading performance unit may add a reference point to the radiomap DB based on the moving information varying whenever the location of the terminal is updated, and may then load the radiomap DB.

The loading performance unit may unload a reference point from the radiomap DB based on the moving information varying whenever the location of the terminal is updated.

The information about the neighboring node of the reference point located in the direction in which the terminal moves may include the number, distance and angle of a reference point neighboring the corresponding reference point.

The reference point neighboring the corresponding reference point may include one or more of a reference point present within a predetermined distance and a reference point present within a shortest distance.

The moving information may include the direction and distance in and by which the terminal has moved from a previous location to a current location.

In accordance with another aspect of the present invention, there is provided a method of loading a radiomap database (DB), including calculating, by a moving information calculation unit, the moving information of a terminal based on the difference between a previous location and estimated final location of the terminal as the terminal moves; and loading, by a loading performance unit, a radiomap DB including information about a neighboring node of a reference point, located in a direction in which the terminal moves, based on a radiomap DB including information about a neighboring node of each reference point and the moving information calculated by the moving information calculation unit.

Loading the radiomap may include adding a reference point to the radiomap DB based on the moving information varying whenever the location of the terminal is updated and then loading the radiomap DB.

Loading the radiomap may include unloading a reference point from the radiomap DB based on the moving information varying whenever the location of the terminal is updated.

The information about the neighboring node of the reference point located in the direction in which the terminal moves may include the number, distance and angle of a reference point neighboring the corresponding reference point.

The reference point neighboring the corresponding reference point may include one or more of a reference point present within a predetermined distance and a reference point present within a shortest distance.

The moving information may include the direction and distance in and by which the terminal has moved from a previous location to a current location.

In accordance with still another aspect of the present invention, there is provided a terminal device, including a radiomap DB loading unit configured to load the radiomap DB of an area, corresponding to the direction and distance in and by which a terminal moves, based on a radiomap DB including moving information resulting from the movement of the terminal and information about a neighboring node of each reference point; and a location estimation unit configured to estimate the location of the corresponding terminal based on the radiomap DB loaded by the radiomap DB loading unit.

The radiomap DB loading unit may include a moving information calculation unit configured to calculate the moving information of the terminal based on the difference between a previous location and estimated final location of the terminal as the terminal moves; and a loading performance unit configured to load a radiomap DB including information about a neighboring node of a reference point, located in a direction in which the terminal moves, based on a radiomap DB including information about a neighboring node of each reference point and the moving information calculated by the moving information calculation unit.

The loading performance unit may add a reference point to the radiomap DB based on the moving information varying whenever the location of the terminal is updated, and may then load the radiomap DB.

The loading performance unit may unload a reference point from the radiomap DB based on the moving information varying whenever the location of the terminal is updated.

The information about the neighboring node of the reference point located in the direction in which the terminal moves may include the number, distance and angle of a reference point neighboring the corresponding reference point.

The reference point neighboring the corresponding reference point may include one or more of a reference point present within a predetermined distance and a reference point present within a shortest distance.

The moving information may include the direction and distance in and by which the terminal has moved from a previous location to a current location.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic diagram illustrating a location estimation system using a radiomap DB, to which the present invention is applied;

FIG. 2 is a diagram illustrating the general format of the radiomap DB illustrated in FIG. 1;

FIG. 3 is a diagram illustrating an example of a constructed radiomap DB;

FIG. 4 is a diagram illustrating the format of a radiomap DB constructed in accordance with an embodiment of the present invention;

FIGS. 5 and 6 are diagrams illustrating the additional items of the radiomap DB illustrated in FIG. 4;

FIG. 7 is a diagram illustrating the internal configuration of a terminal device according to an embodiment of the present invention;

FIG. 8 is a diagram illustrating the internal configuration of the radiomap DB loading unit illustrated in FIG. 7;

FIG. 9 is a flowchart illustrating the sequence of the operation of the estimation system using a radiomap DB, to which the present invention is applied;

FIG. 10 is a flowchart illustrating a method of loading a radiomap DB, which is used for location estimation, according to an embodiment of the present invention;

FIGS. 11 and 12 are diagrams that are used for the description of FIG. 10; and

FIG. 13 is an embodiment of the present invention implemented in a computer system.

### DESCRIPTION OF THE PREFERRED EMBODIMENTS

The present invention may be subjected to various modifications, and may have various embodiments. Specific embodiments are illustrated in the accompanying drawings and described in detail.

However, this is not intended to limit the present invention to the specific embodiments. Rather, it should be appreciated that all modifications, equivalents and replacements included in the spirit and technical range of the present invention fall within the range of the present invention.

The terms used herein are used merely to illustrate specific embodiments, and are not intended to limit the present invention. Unless otherwise stated clearly, a singular expression includes a plural expression. In the specification and claims, it should be understood that the term “comprise,” “include,” “have” and their variants are intended merely to designate the presence of features, numbers, steps, operations, elements, parts or combinations thereof described in the specification, and should not be construed as excluding the presence or additional probability of one or more different features, numbers, steps, operations, elements, parts or combinations thereof.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having meanings that are consistent with their meanings in the context of the relevant art and will not be interpreted in an idealized or overly formal sense unless expressly so defined herein.

Embodiments of the present invention are described in detail below with reference to the accompanying drawings. In the following description of the embodiments, the same reference numerals are assigned to the same elements throughout the drawings and also redundant descriptions of the same elements are omitted, in order to facilitate the overall understanding of the embodiments.

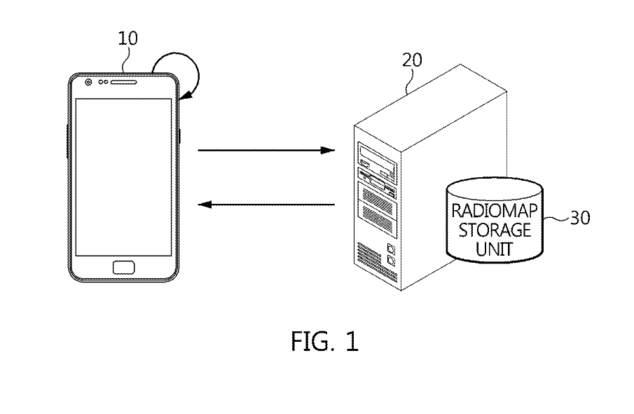

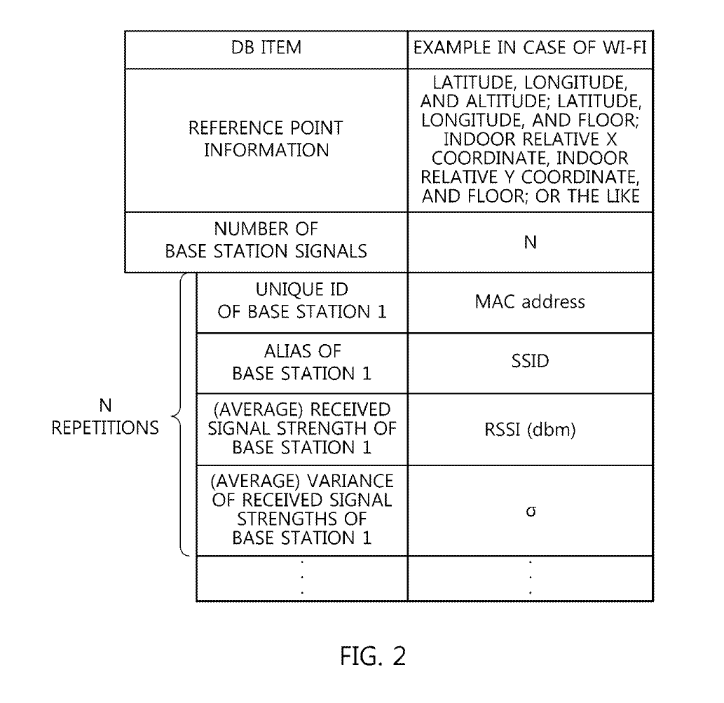

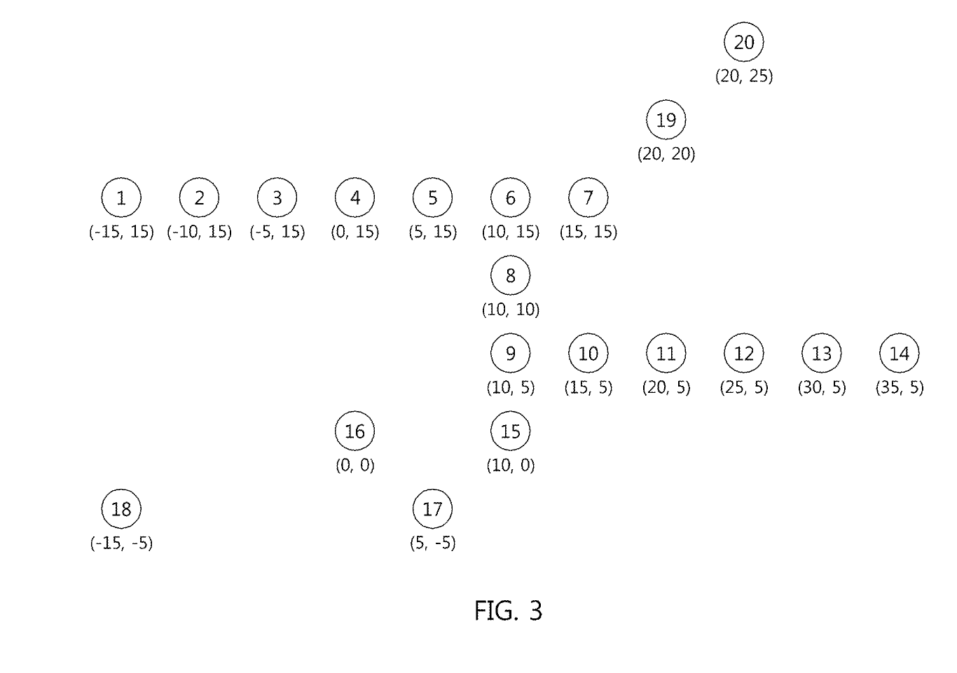

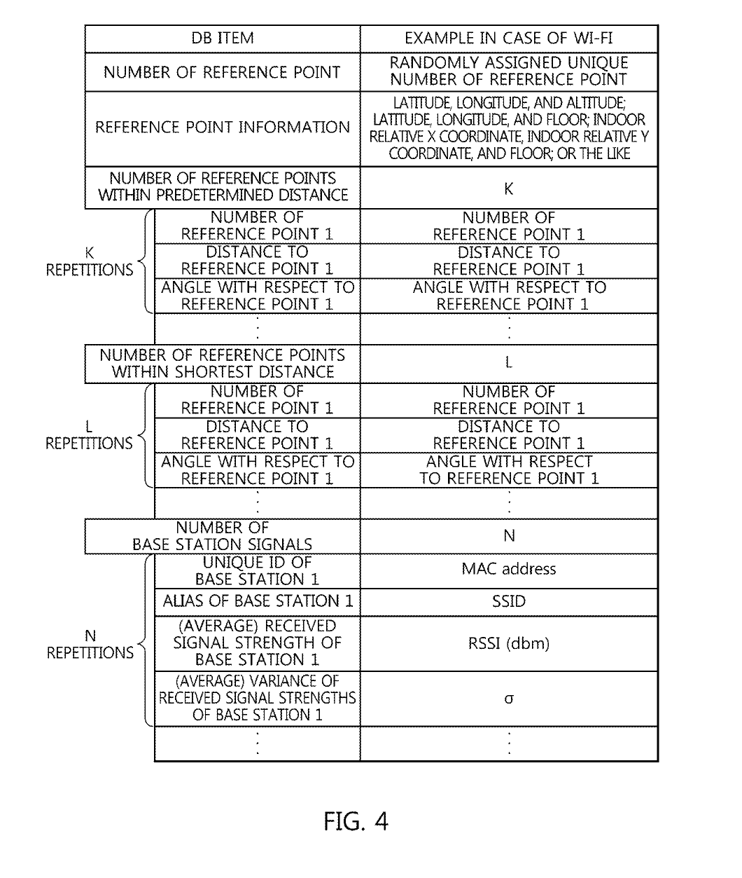

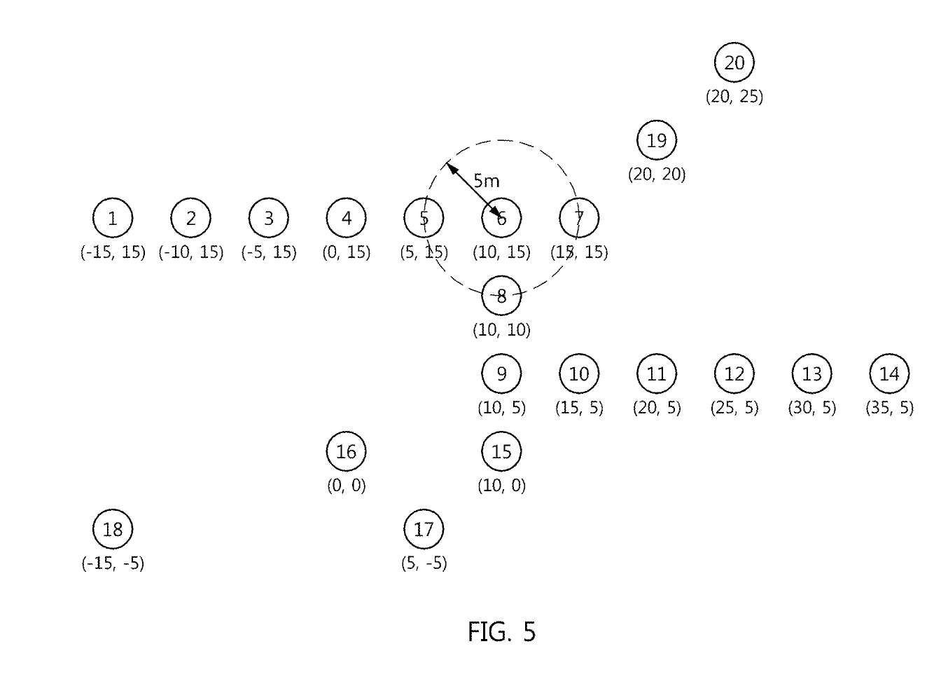

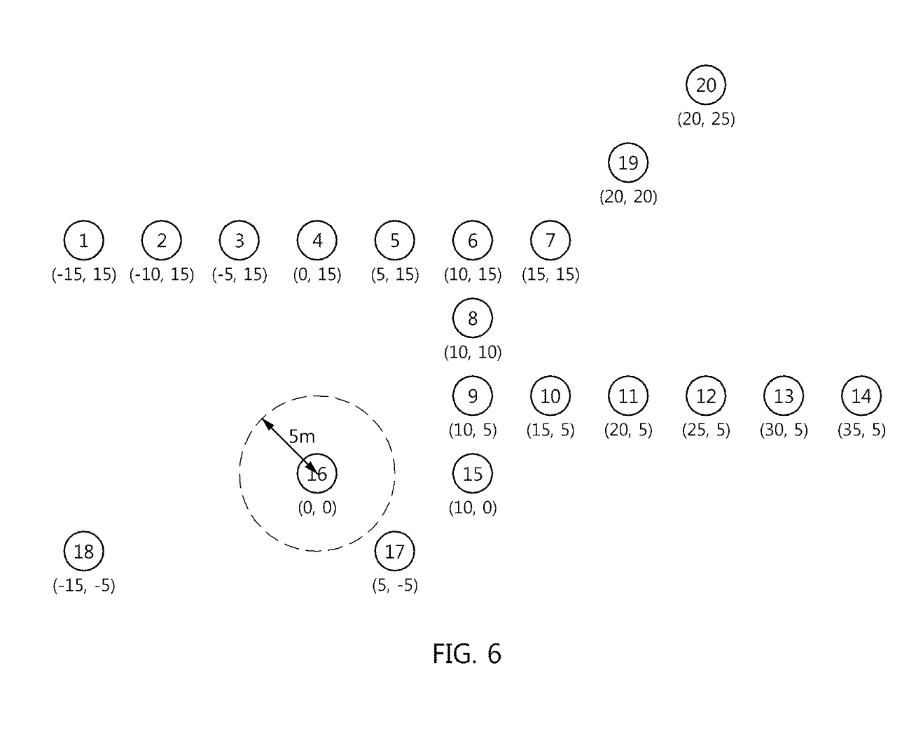

FIG. 1 is a schematic diagram illustrating a location estimation system using a radiomap DB, to which the present invention is applied. FIG. 2 is a diagram illustrating the general format of the radiomap DB illustrated in FIG. 1. FIG. 3 is a diagram illustrating an example of a constructed radiomap DB. FIG. 4 is a diagram illustrating the format of a radiomap DB constructed in accordance with an embodiment of the present invention. FIGS. 5 and 6 are diagrams illustrating the additional items of the radiomap DB illustrated in FIG. 4.

The location estimation system to which the present invention is applied includes a terminal 10, a server 20, and a radiomap storage unit 30.

The terminal 10 estimates the location thereof or the location of a user carrying the terminal 10 using the information of the radiomap storage unit 30. Although representative radiomap DB-based location estimation methods include Nearest Neighbor (NN), k-Nearest Neighbors (kNN) and weighted k-Nearest Neighbors (w-kNN) algorithms, the present invention is limited to any specific method.

The server 20 provides information required for the estimation of a location that is performed by the terminal 10. The server 20 may include a communication unit (not illustrated) configured to communicate with the terminal 10 and a management unit (not illustrated) configured to manage the radiomap storage unit 30.

The radiomap storage unit 30 stores a radiomap (a radiomap in the form of a radiomap data DB) including information, such as received base station information and signal strength, and various types of statistical information at a preset number of multiple reference points within a service area. In an embodiment, a radiomap DB in a service area may be constructed in advance. Methods of constructing a radiomap DB may be divided into a method of directly collecting information at reference points (RPs) and a method of estimating a radiomap using a radio model or the like. The method of directly collecting information at reference points and the method of estimating a radiomap using a radio model will be apparent to those skilled in the art because they are well-known technologies.

When a common radiomap DB is used, the terminal 10 may move. Accordingly, in order to calculate locations again, it is necessary to determine all the items of a radiomap DB while making a recursive round throughout them.

In order to overcome this problem, the radiomap DB of the radiomap storage unit 30 according to an embodiment of the present invention further includes information that enables the direction and distance of a terminal to be determined without requiring a recursive round and also enables valid reference points to be immediately loaded.

Meanwhile, although a method of representing a radiomap DB may be implemented in various manners according to systems, a radiomap DB generally includes information, such as that illustrated in FIG. 2.

In FIG. 2, a reference point is generally a point at which a radiomap has been collected. The number of base station signals is the number of base stations (in the case of Wi-Fi, access points) whose signals have been received at the reference point. The unique IDs and received signal strengths of a number of base stations equal to the number of base stations follow.

When a location is estimated using the above-described general radiomap DB, a reference point having a signal pattern most similar to a signal pattern received by the terminal 10 is estimated to be the current location of the terminal 10 using the radiomap DB. In general, the size of a radiomap DB is proportional to the product of the number of reference points and the number of base station signals. As the range of a service area increases, the size of a radiomap DB increases and also the time it takes to calculate a reference point having the most similar signal pattern increases.

In particular, systems in which continuous location estimation should be performed, such as a road guidance service system, require a fast location estimation algorithm that is capable of implementing fast location estimation based on an additional task, such as the task of limiting the number of reference points or the task of limiting the range of a radiomap.

Accordingly, in order to adaptively load a radiomap DB whenever the location of a moving terminal is updated, it is possible to load a radiomap suitable for the direction and distance of the moving terminal only if information about the arrangement of reference points within a radiomap DB has been known. At least one embodiment of the present invention has solved this issue by adding a few pieces of information to an existing radiomap DB.

Referring to the radiomap DB illustrated in FIG. 3, circles represent reference points, and the numbers inside the circles are random (unique) numbers assigned to the reference points. The coordinates under the circles are indoor relative coordinates (X, Y) representative of the locations of the reference points.

When FIG. 3 is represented in the form of a general radiomap DB, the following Table 1 is obtained:

TABLE 1

| | | | | | | (Average) | Variance of | |
|---|---|---|---|---|---|---|---|---|
| | | | | | | Received | received | |
| | | | Number | Unique | Alias of | signal | signal | |
| | | | of base | ID of | base | strength of | strengths of | |
| Reference | Reference | Reference | station | base station | station | base station | base station | |
| point No. | point X | point Y | signals | No. 1 | No. 1 | No. 1 | No. 1 | . . . |
| 1 | −15 | 15 | 3 | 000000001 A | Free | −50 | 3.5 | . . . |
| | | | | | WiFi | | | |
| 2 | −10 | 15 | 2 | 000000001 A | Free | −55 | 4.3 | . . . |
| | | | | | WiFi | | | |
| 3 | −5 | 15 | 3 | 000000001 A | Free | −70 | 2.3 | . . . |
| | | | | | WiFi | | | |
| . | . | . | . | . | . | . | . | . |
| . | . | . | . | . | . | . | . | . |
| . | . | . | . | . | . | . | . | . |

Using the general radiomap DB of FIG. 3, a list of base stations found at each reference point and signal strengths at the reference point can be determined However, there is no information about the arrangement and connections between each reference point and other reference points, and thus it is necessary to determine the location of a terminal while making a recursive round throughout all the items of the radiomap DB in order to calculate the location again when the terminal moves.

Accordingly, in order to overcome the above problem and thus to determine the direction and distance of the terminal without requiring a recursive round and immediately load valid reference points, the following two items are added to each reference point in the radiomap DB according to the present invention. While both of the following two items may be added, any one of the items may be added in some cases.

(1) {numbers of reference points within a predetermined distance, and related distances and angles}

(2) {numbers of reference points within the closest distance, and related distances and angles}

The format of the radiomap DB that supports the two items (which may be referred to as information about the arrangement of reference points or information about the neighboring nodes of each reference point) added to each reference point as described above is illustrated in FIG. 4.

For example, assuming that the “predetermined distance” is 5 m, as illustrated in FIG. 5, the items that are added to reference point No. 6 are as follows:

(1) {5, 5 m, 180°}, {7, 5 m, 0°}, {8, 5 m, 270°}

(2) {5, 5 m, 180°}, {7, 5 m, 0°}, {8, 5 m, 270°}

That is, the reference points within a predetermined distance of 5 m from reference point No. 6 are reference points Nos. 5, 7 and 8. Furthermore, all the reference points Nos. 5, 7 and 8 are present within a distance corresponding to a radius of 5 m, and the angles the reference points Nos. 5, 7 and 8 with respect to the reference point No. 6 are 180°, 0° and 270°. The reference points closest to the reference point No. 6 are also reference points Nos. 5, 7 and 8.

As another example, referring to an example of the radiomap DB illustrated in FIG. 6, the items that are added to the reference point No. 16 are as follows:

(1) None

(2) {17, 7.07 m, 315°}

That is, a reference point located within a predetermined distance of 5 m around reference point No. 16 is not present in FIG. 6. The closest reference point is reference point No. 17. The distance is about 7.07 m, and is located in a direction toward 315° with respect to the reference point No. 16.

As described above, the radiomap storage unit 30 may store a radiomap DB to which information about reference points within a predetermined distance and information about the closest reference point has been added. Accordingly, since the information about reference points within a predetermined distance and the information about the closest reference point has been added, it is easy to become aware of information about the arrangement of reference points.

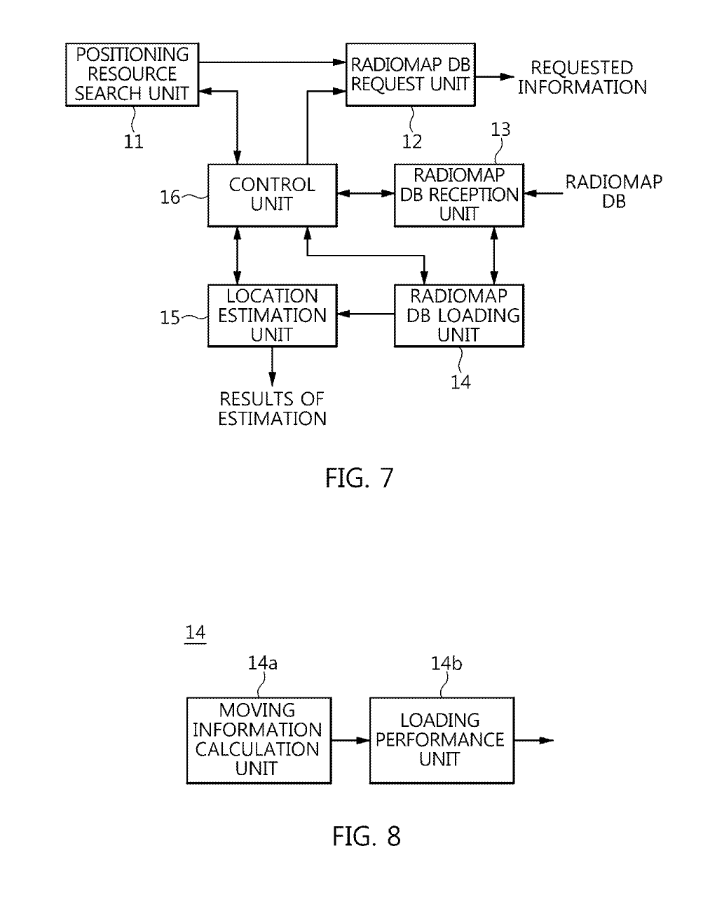

FIG. 7 is a diagram illustrating the internal configuration of a terminal device according to an embodiment of the present invention.

The terminal device (i.e., the terminal 10) according to this embodiment of the present invention includes a positioning resource search unit 11, a radiomap DB request unit 12, a radiomap DB reception unit 13, a radiomap DB loading unit 14, a location estimation unit 15, and a control unit 16.

The positioning resource search unit 11 searches for positioning resources around the corresponding terminal 10. In this case, the positioning resources may be considered to be radio waves used in a mobile communication network, radio waves used in a wireless local area network (WLAN) (a Wi-Fi network or the like), and radio waves used in a wireless personal area network (WPAN) (a Bluetooth, UWB, or Zigbee network), but are not limited thereto. The following description is given based on a Wi-Fi network for ease of understanding.

The radiomap DB request unit 12 transmits the results of the searching for the positioning resources to the server 20 under the control of the control unit 16. Furthermore, the radiomap DB request unit 12 transmits a message requesting a radiomap DB around the corresponding terminal 10 to the server 20 under the control of control unit 16.

The radiomap DB reception unit 13 receives a radiomap DB from the server 20. Although not illustrated, the radiomap DB reception unit 13 may include memory configured to store a received radiomap DB.

To estimate the location of the corresponding terminal 10, the radiomap DB loading unit 14 loads the radiomap DB received from the radiomap DB reception unit 13. In particular, the radiomap DB loading unit 14 adaptively loads a radiomap DB whenever the terminal 10 moves and then the location of the terminal 10 is updated.

In other words, the radiomap DB loading unit 14 loads the radiomap DB of a service area corresponding to the direction and distance in and by which the corresponding terminal 10 moves based on information the arrangement of reference points (that is, information about the neighboring nodes of each reference point) within the received radiomap DB. That is, the radiomap DB loading unit 14 performs selective and efficient loading and unloading using information about the arrangement of the neighboring reference points of each reference point when the location of the terminal 10 is updated and thus a radiomap should be reloaded.

Once the radiomap DB loading unit 14 has completed the loading, the location estimation unit 15 estimates the location of the corresponding terminal 10 using the loaded radiomap DB. Radiomap DB-based location estimation methods may include Nearest Neighbor (NN), k-Nearest Neighbors (kNN), weighted k-Nearest Neighbors (w-kNN) algorithms.

The location estimation unit 15 displays results on a display unit (not illustrated) when the estimation of the location of the corresponding terminal 10 has been completed.

The control unit 16 controls the overall operation of the corresponding terminal 10.

FIG. 8 is a diagram illustrating the internal configuration of the radiomap DB loading unit illustrated in FIG. 7, which may be considered to be a diagram illustrating the internal configuration of a radiomap DB loading device that is intended to be implemented in the present invention.

The radiomap DB loading unit 14 includes a moving information calculation unit 14a, and a loading performance unit 14b.

The moving information calculation unit 14a calculates moving information based on the movement of the corresponding terminal 10. In an embodiment, the moving information calculation unit 14a calculates moving information including the direction and distance in and by which the corresponding terminal 10 or a user carrying the terminal 10 moves from a previous location to a current location.

When the moving information calculation unit 14a calculates the moving information of the terminal 10 with respect to a previous location, the loading performance unit 14b loads a radiomap (that is, the reference points of the radiomap DB) located in the direction in which the terminal 10 moves based on the moving information. That is, the loading performance unit 14b loads a radiomap DB (that is, a radiomap DB including information about the neighboring nodes of each reference point located in the direction in which the terminal 10 moves) based on the moving information calculated by the moving information calculation unit 14a and the radiomap DB received.

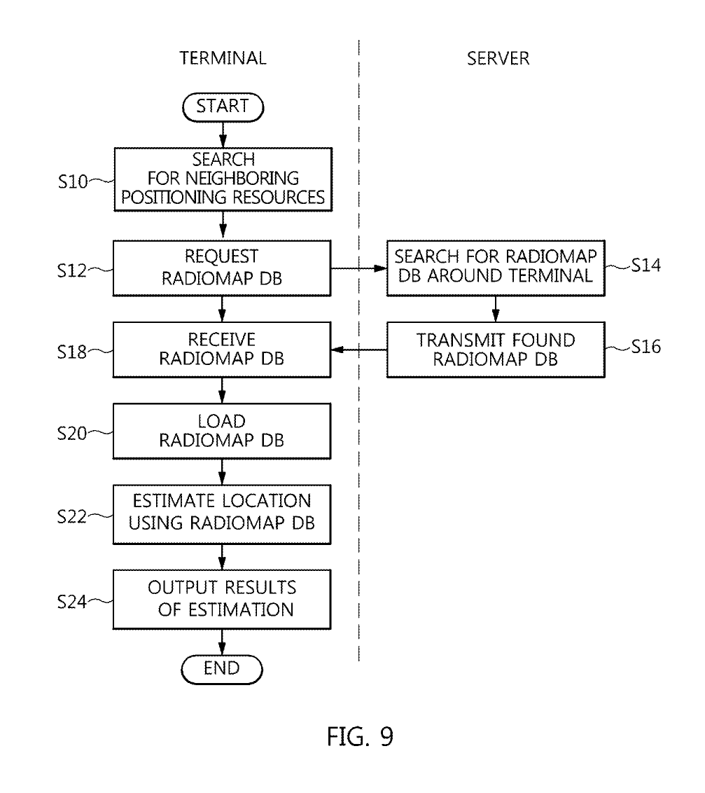

FIG. 9 is a flowchart illustrating the sequence of the operation of the estimation system using a radiomap DB, to which the present invention is applied.

In order to estimate the location of the terminal 10, the positioning resource search unit 11 of the terminal 10 searches for positioning resources around the corresponding terminal 10 at step S10.

Once the positioning resource search unit 11 has found the positioning resources, the radiomap DB request unit 12 of the corresponding terminal 10 requests the radiomap DB of an area around the terminal 10 by transmitting the search results of the positioning resource search unit 11 to the server 20 at step S12.

The server 20 receives the search results and then searches for the radiomap DB of an area around the corresponding terminal in the radiomap storage unit 30 in which a radiomap has been stored in the form of a DB at step S14.

Thereafter, the server 20 transmits the found radiomap DB to the corresponding terminal 10 at step S16.

Accordingly, the terminal 10 receives the radiomap DB and becomes ready to perform the estimation of a location at step S18.

If the terminal 10 already has the radiomap DB of the corresponding service area, steps S12 to S18 of requesting and receiving the radiomap DB may be omitted.

Thereafter, in order to estimate the location of the terminal 10, the radiomap DB loading unit 14 of the corresponding terminal 10 loads the received radiomap DB or a previously held radiomap DB at step S20. In this case, the terminal 10 calculates the moving information of the terminal 10 with respect to the previous location and loads a desired radiomap DB based on the calculated moving information and the received radiomap DB. That is, the terminal 10 loads reference points located in the direction the corresponding terminal 10 moves, and also loads neighboring nodes (neighboring reference points) of the reference points.

Once the loading has been completed, the location estimation unit 15 of the corresponding terminal 10 estimates the location of the corresponding terminal 10 using the loaded radiomap DB at step S22. In this case, in radiomap DB-based location estimation, a radiomap DB is massive, and thus only part thereof is loaded into the memory of the terminal and then correlation analysis is performed. That is, the received radiomap DB at step S18 means the “overall radiomap DB of the corresponding service area.” Since the overall radiomap DB of the corresponding service area is commonly constructed on an area basis, a building basis and a floor basis, it is stored in the form of files or databases. Accordingly, only a radiomap corresponding to an area close to an area where the terminal 10 is actually located is loaded into memory. This is intended to reduce the range of a radiomap (or the number of radiomaps) to be loaded by taking into account the characteristics of a radiomap DB technique in which the correlations between radio waves (Wi-Fi waves) received at the current terminal and the loaded radiomap. Furthermore, this is essential from the perspective of the memory management of the terminal 10.

Once the estimation of the location has been completed, the results of the estimation are output at step S24.

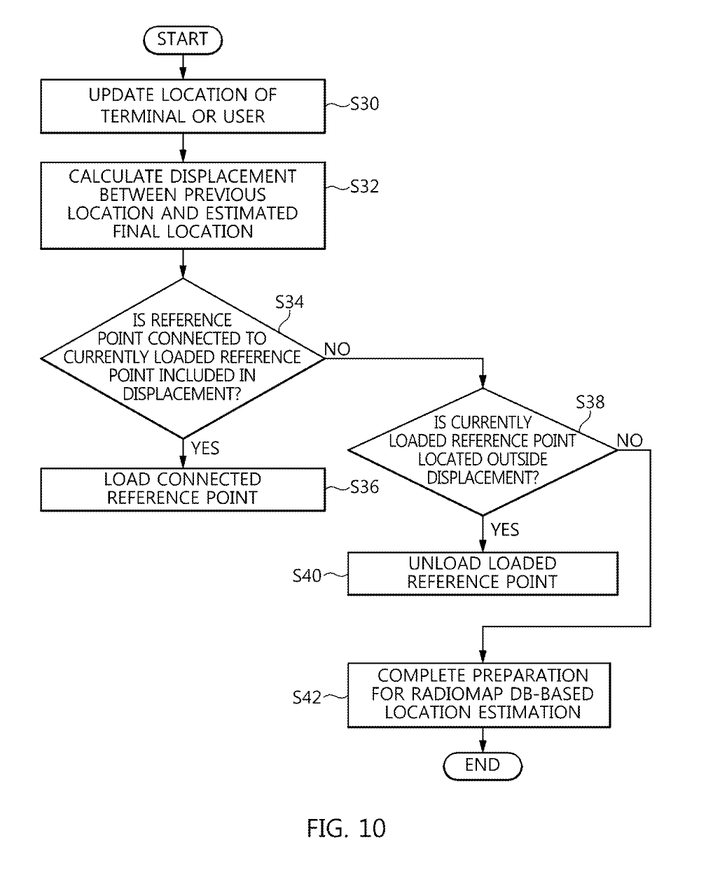

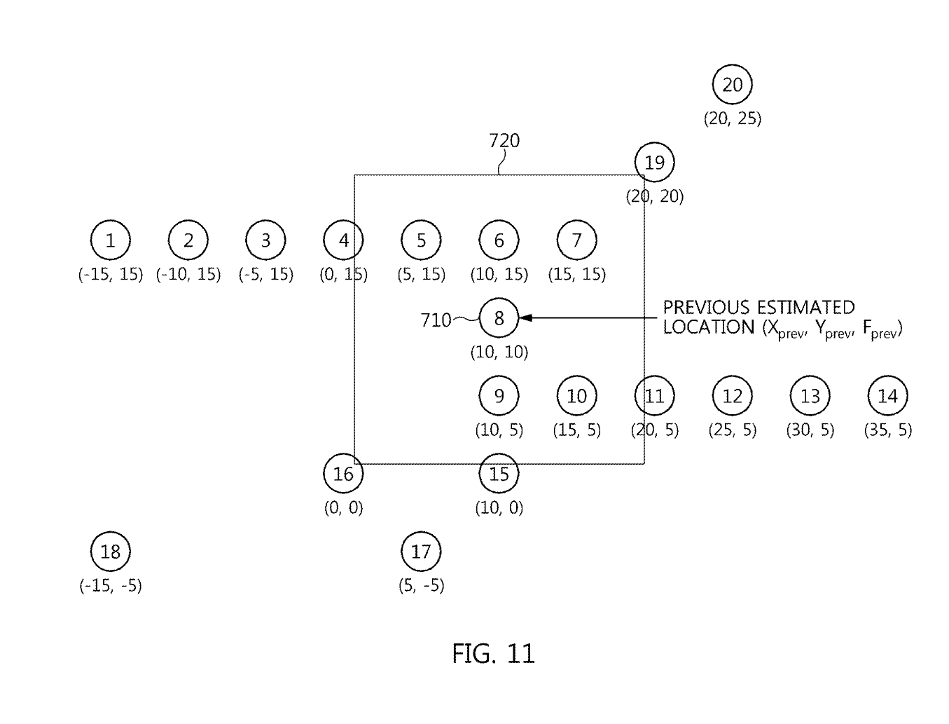

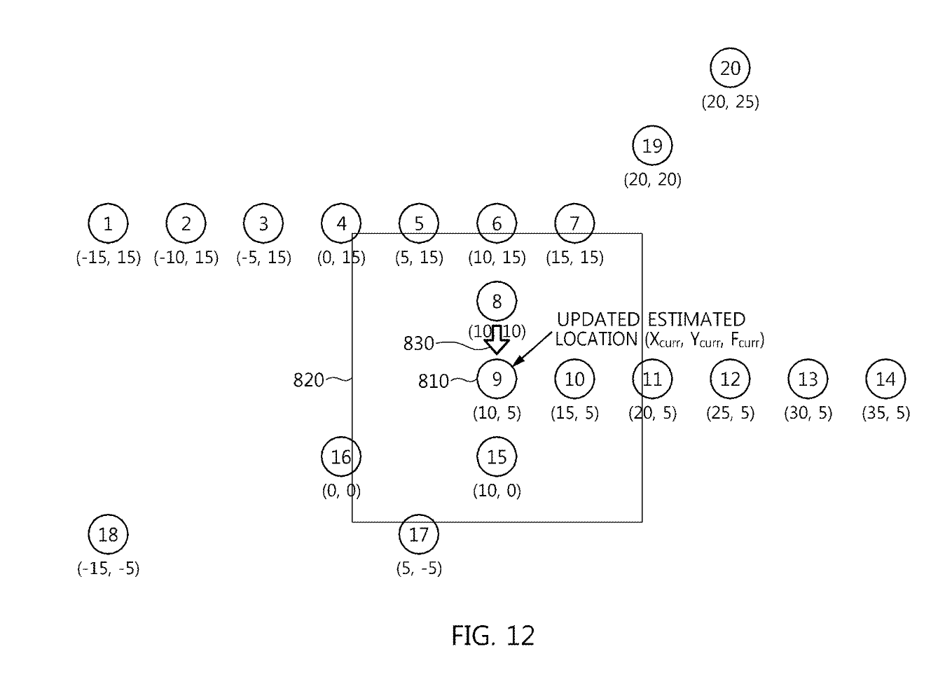

FIG. 10 is a flowchart illustrating a method of loading a radiomap DB, which is used for location estimation, according to an embodiment of the present invention. That is, FIG. 10 illustrates a method of, upon estimating a location using a radiomap DB in the case of a service requiring continuous location estimation, adaptively loading a radiomap DB whenever a location is updated. FIGS. 11 and 12 are diagrams that are used for the description of FIG. 10. The method of loading radiomap DB, which is used for location estimation, is understood as the detailed operation of the radiomap DB loading unit 14.

Once the location of the terminal 10 has been finally updated at step S30, the moving information calculation unit 14a calculates the difference between the previous location and the estimated final location at step S32. In the case of indoor location estimation technology, this difference is simply represented, as follows:

A coordinate system may be represented in the form of (indoor relative X coordinate, indoor relative Y coordinate, indoor floor information). Accordingly, the previous location is presented by “(Xprev, Yprev, Fprev),” whereas the current location is presented by “(Xcurr, Ycurr, Fcurr).”

Furthermore, the moving distance D is “D=√(Xcurr−Xprev)²+(Ycurr−Yprev)²,”|Fcurr−Fprev|.

Therefore, the moving information V may be “V=(A, D).” In this case, A is the angle of the current location with respect to the previous location.

As described above, the moving information V represents the angle and distance of the current location with respect to the previous location. This corresponds to the direction and distance in and by which the user has moved from the previous location to the current location. Furthermore, the angle between the two locations may be calculated using “arctan.”

When the moving information calculation unit 14a calculates the moving information of the terminal with respect to the previous location, the loading performance unit 14b loads the reference points of a radiomap DB, located in the direction in which the terminal 10 moves, accordingly. This is performed after whether a reference point connected to each currently loaded reference point is included in a displacement has been determined That is, for example, in FIG. 11, the previously estimated location is “710.” In this case, the range of reference points of the loaded radiomap is “720,” and the numbers of the loaded reference points are 5, 6, 7, 8, 9 and 10.

If the terminal 10 has moved from a location close to reference point No. 8 to a location close to reference point No. 9 and then updated, the location of the corresponding terminal 10 is “810,” as illustrated in FIG. 12. In this case, the moving displacement may be calculated as “830.” When the difference between the previously estimated location “(10, 10)” and the current location “(10, 5)” is calculated, V=(270°, 5 m). That is, the terminal 10 has moved by a distance of 5 m in a direction toward 270°.

The loading performance unit 14b determines whether a reference point connected to the currently loaded reference point is included in a displacement using the information at step S34.

At step S36, the loading performance unit 14b loads the connected reference point if the reference point connected to the currently loaded reference point is included in the displacement. That is, the loading performance unit 14b may be viewed as adding a reference point to the radiomap DB and then loading the radiomap DB based on the moving information varying whenever the location of the terminal 10 is updated. In other words, the loading performance unit 14b loads an additional reference point in correspondence with the moving information varying whenever the location of the terminal 10 is updated based on the reference point of the currently loaded radiomap.

However, when the reference point connected to the currently loaded reference point is not included in the displacement and the currently loaded reference point is located outside the displacement (“Yes” at step S38), the loading performance unit 14b unloads the loaded reference point at step S40. That is, the loading performance unit 14b may be viewed as being capable of removing a reference point from the radiomap DB based on the moving information varying whenever the location of the terminal 10 is updated. In other words, the loading performance unit 14b unloads a reference point (that is, an unnecessary reference point) of the loaded radiomap in accordance with the moving information varying whenever the location of the terminal 10 is updated.

For example, reference point No. 4 connected to reference point No. 5 is not loaded because it is located in a direction toward 180°, rather than toward 270°, with respect to the reference point No. 5. Reference point No. 15 connected to reference point No. 9 is not loaded because it is located within a distance of 5 m in a direction toward 270° with respect to reference point No. 9. Reference point No. 11 connected to reference point No. 10 is not loaded because it is located in a direction toward 0° with respect to reference point No. 10.

The above-described steps S34 and S36 may be performed on all the loaded reference points, or may be performed on the outside nodes (that is, in FIG. 11, reference points Nos. 5, 6, 7, 9 and 10) of the loaded reference points.

In contrast, in FIG. 12, the reference point numbers Nos. 5, 6 and 7 are located outside area “820” when the displacement is applied. Based on the above-described steps S38 and S40, the radiomap (that is, the reference points Nos. 5, 6 and 7) is unloaded.

Using the above-described method, an optimum radiomap is adaptively loaded in response to the terminal 10 at step S42.

As described above, an optimum loading state is maintained, and thus rapid and accurate calculation can be performed upon performing radiomap DB-based location estimation.

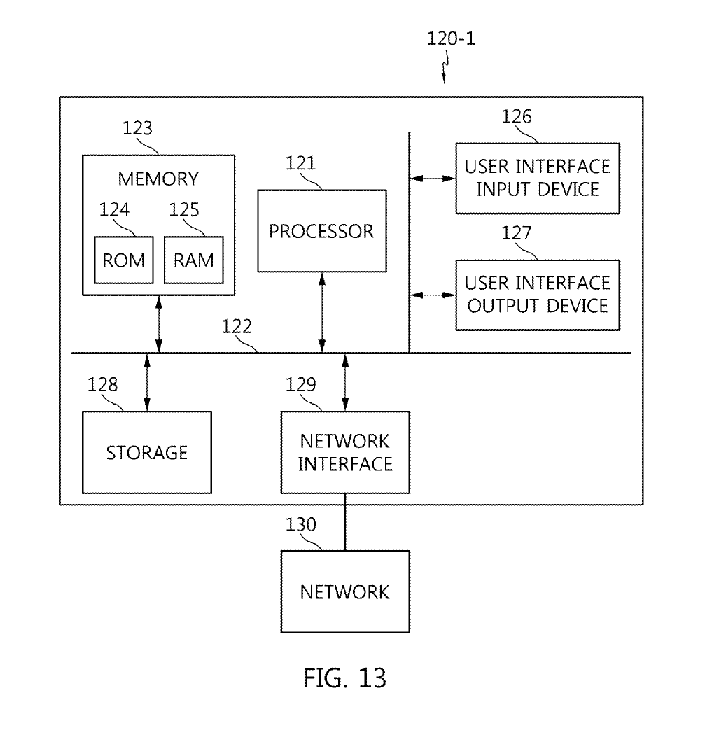

FIG. 13 is an embodiment of the present invention implemented in a computer system.

Refering to FIG. 13, an embodiment of the present invention may be implemented in a computer system, e.g., as a computer readable medium. As shown in in FIG. 13, a computer system 120-1 may include one or more of a processor 121, a memory 123, a user input device 126, a user output device 127, and a storage 128, each of which communicates through a bus 122. The computer system 120-1 may also include a network interface 129 that is coupled to a network 130. The processor 121 may be a central processing unit (CPU) or a semiconductor device that executes processing instructions stored in the memory 123 and/or the storage 128. The memory 123 and the storage 128 may include various forms of volatile or non-volatile storage media. For example, the memory may include a read-only memory (ROM) 124 and a random access memory (RAM) 125.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

In accordance with at least one embodiment of the present invention having the above-described configuration, it is possible to immediately determine a target radiomap using information about a neighboring node of each reference point of a radiomap DB without searching an overall radiomap DB again and then load or unload the radiomap, thereby overcoming the limitation of the conventional technology in which, in a service requiring continuous location estimation, an overall range should be searched again in order to search for a radiomap that should be loaded as the location of a terminal changes.

In particular, in the case where the number of reference points which should be continuously searched for is large, such as the case where a service area is wide or the case where the density of the reference points of the radiomap DB of an area is high, the present invention can bring about a significant improvement of performance.

In accordance with at least one embodiment of the present invention having the above-described configuration, it is possible to rapidly and effectively calculate successive and highly accurate locations in indoor and outdoor areas based on the technology presented by the present invention, thereby extending the range of application of location-based service.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. An apparatus for loading a radiomap database (DB), comprising:
a moving information calculation unit configured to calculate moving information of a terminal based on a difference between a previous location and estimated final location of the terminal as the terminal moves; and
a loading performance unit configured to load a radiomap DB including information about a neighboring node of a reference point, located in a direction in which the terminal moves, based on a radiomap DB including information about a neighboring node of each reference point and the moving information calculated by the moving information calculation unit.

2. The apparatus of claim 1, wherein the loading performance unit adds a reference point to the radiomap DB based on the moving information varying whenever a location of the terminal is updated, and then loads the radiomap DB.

3. The apparatus of claim 1, wherein the loading performance unit unloads a reference point from the radiomap DB based on the moving information varying whenever a location of the terminal is updated.

4. The apparatus of claim 1, wherein the information about the neighboring node of the reference point located in the direction in which the terminal moves comprises a number, distance and angle of a reference point neighboring the corresponding reference point.

5. The apparatus of claim 4, wherein the reference point neighboring the corresponding reference point comprises one or more of a reference point present within a predetermined distance and a reference point present within a shortest distance.

6. The apparatus of claim 1, wherein the moving information comprises a direction and distance in and by which the terminal has moved from a previous location to a current location.

7. A method of loading a radiomap database (DB), comprising:
calculating, by a moving information calculation unit, moving information of a terminal based on a difference between a previous location and estimated final location of the terminal as the terminal moves; and
loading, by a loading performance unit, a radiomap DB including information about a neighboring node of a reference point, located in a direction in which the terminal moves, based on a radiomap DB including information about a neighboring node of each reference point and the moving information calculated by the moving information calculation unit.

8. The method of claim 7, wherein loading the radiomap comprises adding a reference point to the radiomap DB based on the moving information varying whenever a location of the terminal is updated and then loading the radiomap DB.

9. The method of claim 7, wherein loading the radiomap comprises unloading a reference point from the radiomap DB based on the moving information varying whenever a location of the terminal is updated.

10. The method of claim 7, wherein the information about the neighboring node of the reference point located in the direction in which the terminal moves comprises a number, distance and angle of a reference point neighboring the corresponding reference point.

11. The method of claim 10, wherein the reference point neighboring the corresponding reference point comprises one or more of a reference point present within a predetermined distance and a reference point present within a shortest distance.

12. The method of claim 7, wherein the moving information comprises a direction and distance in and by which the terminal has moved from a previous location to a current location.

13. A terminal device, comprising:
a radiomap DB loading unit configured to load a radiomap DB of an area, corresponding to a direction and distance in and by which a terminal moves, based on a radiomap DB including moving information resulting from the movement of the terminal and information about a neighboring node of each reference point; and
a location estimation unit configured to estimate a location of the corresponding terminal based on the radiomap DB loaded by the radiomap DB loading unit.

14. The terminal device of claim 13, wherein the radiomap DB loading unit comprises:
a moving information calculation unit configured to calculate moving information of the terminal based on a difference between a previous location and estimated final location of the terminal as the terminal moves; and
a loading performance unit configured to load a radiomap DB including information about a neighboring node of a reference point, located in a direction in which the terminal moves, based on a radiomap DB including information about a neighboring node of each reference point and the moving information calculated by the moving information calculation unit.

15. The terminal device of claim 14, wherein the loading performance unit adds a reference point to the radiomap DB based on the moving information varying whenever a location of the terminal is updated, and then loads the radiomap DB.

16. The terminal device of claim 14, wherein the loading performance unit unloads a reference point from the radiomap DB based on the moving information varying whenever a location of the terminal is updated.

17. The terminal device of claim 14, wherein the information about the neighboring node of the reference point located in the direction in which the terminal moves comprises a number, distance and angle of a reference point neighboring the corresponding reference point.

18. The terminal device of claim 17, wherein the reference point neighboring the corresponding reference point comprises one or more of a reference point present within a predetermined distance and a reference point present within a shortest distance.

19. The terminal device of claim 14, wherein the moving information comprises a direction and distance in and by which the terminal has moved from a previous location to a current location.
